(19) United States
(12) Patent Application Publication
(10) Pub. No.: US 2015/0330792 A1
(43) Pub. Date: Nov. 19, 2015

(54) DEVICE FOR OUTPUTTING A MEASUREMENT SIGNAL INDICATING A PHYSICAL MEASUREMENT VARIABLE

(71) Applicant: Continental Teves AG & Co. OHG, Frankfurt (DE)

(72) Inventors: Ulrich Stählin, Eschborn (DE); Sven Kretschmar, Gustavsburg (DE)

(21) Appl. No.: 14/651,288

(22) PCT Filed: Dec. 13, 2013
(86) PCT No.: PCT/EP2013/076500

§ 371 Date: Jun. 11, 2015

(30) Foreign Application Priority Data
Dec. 20, 2012 (DE) 10 2012 224 103.5

(51) Int. Cl. G01C 21/16

(52) U.S. Cl. CPC G01C 21/16

(57) ABSTRACT

A device for outputting a measurement signal indicating a physical measurement variable in a vehicle, the device—a first processor that is designed to determine, on the basis of a first sensor signal a first comparison signal for the physical measurement variable, a second processor that is designed to determine, on the basis of a second sensor signal, a second comparison signal for the physical measurement variable and—a filter device that is designed to determine an error between the two comparison signals and to output this error to the first processor,—wherein the first processor is designed to determine the measurement signal on the basis of a correction of the first comparison signal taking into account the error.

### CROSS REFERENCE TO RELATED APPLICATIONS

This application is the U.S. National Phase Application of PCT International Application No. PCT/EP2013/076500, filed Dec. 13, 2013, which claims priority to German Patent Application No. 10 2012 224 103.5, filed Dec. 20, 2012, the contents of such applications being incorporated by reference herein.

### FIELD OF THE INVENTION

The invention relates to an apparatus, in a vehicle, for outputting a measurement signal that indicates a physical measured variable and to a vehicle having the apparatus.

### BACKGROUND OF THE INVENTION

WO 2011/098 333 A1 being incorporated by reference herein discloses the practice of using various sensor variables in a vehicle in order to improve already existent sensor variables on the basis of a fusion or to generate new sensor variables and hence to enhance the ascertainable information.

### SUMMARY OF THE INVENTION

An aspect of the invention aims to improve the use of a plurality of sensor variables for the purpose of enhancing information.

According to one aspect of the invention, an apparatus for outputting a measurement signal that indicates a physical measured variable in a vehicle comprises a first processor that is set up to take a first sensor signal as a basis for determining a first comparison signal for the physical measured variable, a second processor that is set up to take a second sensor signal as a basis for determining a second comparison signal for the physical variable, and a filter device that is set up to determine an error between the two comparison signals and to output said error to the first processor, wherein the first processor is set up to determine the measurement signal on the basis of a correction of the first comparison signal taking into account the error.

The specified apparatus is based on the consideration that the results of the sensor variable fusion cited at the outset and hence the desired measurement signal should be output with a very high safety level of, by way of example, ASIL B or even ASIL D from ISO standard ISO 26262. An appropriate algorithm that meets such a high requirement for safety on the measurement signal immediately entails a correspondingly high level of computation complexity, however, that requires a correspondingly high level of processor power in order to depict the output of the measurement signal with the desired safety level.

By contrast, however, the specified apparatus involves the recognition that just basic safety in the output of the measurement signal can be achieved if the comparison signals on which the sensor fusion is based are determined on separate processors. In this case, one of the two processors could fail and there would still be a comparison signal available that could be used alternatively as a measurement signal with a lower quality factor. This means that it is possible to dispense with use of an aforementioned computation-resource-intensive algorithm for implementing the high safety level, since the safety level can be realized just through the use of two redundant but inexpensive processors.

Although the sensor signals and the measurement signal could describe any physical variable, such as tire pressure, tire radius and so on, one development of the specified apparatus involves one of the sensor signals being a global satellite navigation signal, called GNSS signal below, and the other of the sensor signals being a driving dynamics signal and the physical measured variable being a locating signal that locates the vehicle in terms of its absolute position and its change of position. If the driving dynamics signal for the processor that determines the sensor fusion fails, for example, then the driving dynamics data could be derived at least rudimentarily from the GNSS signal in order to deduce the motion of the vehicle, for example for rudimentary electronic stability control. A similar response is obtained in the event of failure of the processor that determines the GNSS signal as part of the sensor fusion. In this case, by way of example, the aversion to an inherently known loosely coupled approach could interpolate the locating data for the vehicle, which locating data can be deduced from the GNSS signal, on the basis of the driving dynamics data.

In another development of the specified apparatus, at least one processor is set up to monitor the accordingly other processor. This would allow an erroneously operating processor to be identified and suitable countermeasures to be initiated that transfer the vehicle to a non-safety-critical driving state, for example. If the driving dynamics data disappear, for example, the vehicle could be transferred to an emergency mode of operation, in which a particular maximum speed for the vehicle is permitted that would allow rudimentary electronic stability control even with driving dynamics data that are derived from the GNSS signal. Alternatively or additionally, the next garage could be sought for the vehicle on a navigation appliance and displayed to the driver.

In an additional development of the specified apparatus, the monitoring processor is set up to compute a residual between the comparison signal from the monitored processor and a model for the physical measured variable. A residual is intended to be understood below to mean a discrepancy that arises when, instead of ideal solution data, the data from the comparison signal are inserted into the model. The residual is therefore an indicator of an error in the comparison signal from the monitored processor, which can be reliably found by virtue of the independent computation on the processor that is to be monitored.

In a particular development of the specified apparatus the monitoring processor is set up to monitor the operation of the monitored processor on the basis of contrasting of the computed residual and a setpoint value, as a result of which a criterion is stipulated for the time from which an error can be determined.

In a preferred development of the specified apparatus, the monitoring processor is set up to output its determined comparison signal as a measurement signal when the operation of the monitored processor is identified as erroneous. This allows the monitoring processor to bypass the failure of the measurement signal on account of the sensor fusion not working until the failure has been rectified in a garage, for example.

In a particularly preferred development of the specified apparatus, in the event of error in the monitored processor, the monitoring processor is set up to provide the measurement signal with a piece of information about the failure of the monitored processor. This allows other actuators, control loops or controllers to identify the failure of the poorer data integrity of the comparison signal, which is used as a measurement signal, from the still error-free processor and to orient their operation thereto. By way of example, electronic stability control can switch off under certain conditions or entirely so as not to put the vehicle into traffic-critical situations as a result of unstable control.

In yet another development of the specified apparatus, the monitoring processor is set up to logically combine, and output, its comparison signal with the computed residual. By way of example, the output can be provided continuously and regardless of the error situation in the monitored processor. This allows the receiver of the comparison signal itself to decide whether to use the comparison signal as a measurement signal or the measurement signal from the sensor fusion.

In an alternative development of the specified apparatus, the monitoring processor is a cryptoprocessor that performs its processes in a manner that cannot be reconstructed externally, for example through system analysis. This renders manipulation of the monitoring processor difficult. Particularly advantageously, the cryptoprocessor chosen should be the processor on which no process executing the filter device is running and that is therefore subject to the lowest computation complexity. The cryptoprocessor can therefore be chosen to be of correspondingly lower power, which sometimes allows use just as a cryptoprocessor. The cryptoprocessor can preferably plausibilize the comparison signal from the monitored processor and subsequently send the plausibilization result directly itself, since other vehicle components are thus provided with a reliable and above all manipulation-free status report about the monitored processor.

According to a further aspect of the invention, a vehicle comprises a specified apparatus.

### BRIEF DESCRIPTION OF THE DRAWINGS

The properties, features and advantages of this invention that are described above and also the way in which they are achieved will become clearer and more distinctly comprehensible in connection with the description of the exemplary embodiments that follows, said exemplary embodiments being explained in more detail in connection with the drawings, in which:

FIG. 1 shows a basic illustration of a vehicle with a fusion sensor, and

FIG. 2 shows a basic illustration of the fusion sensor from FIG. 1.

### DETAILED DESCRIPTION OF THE PREFERRED EMBODIMENTS

In the figures, technical elements that are the same are provided with the same reference symbols and are described only once.

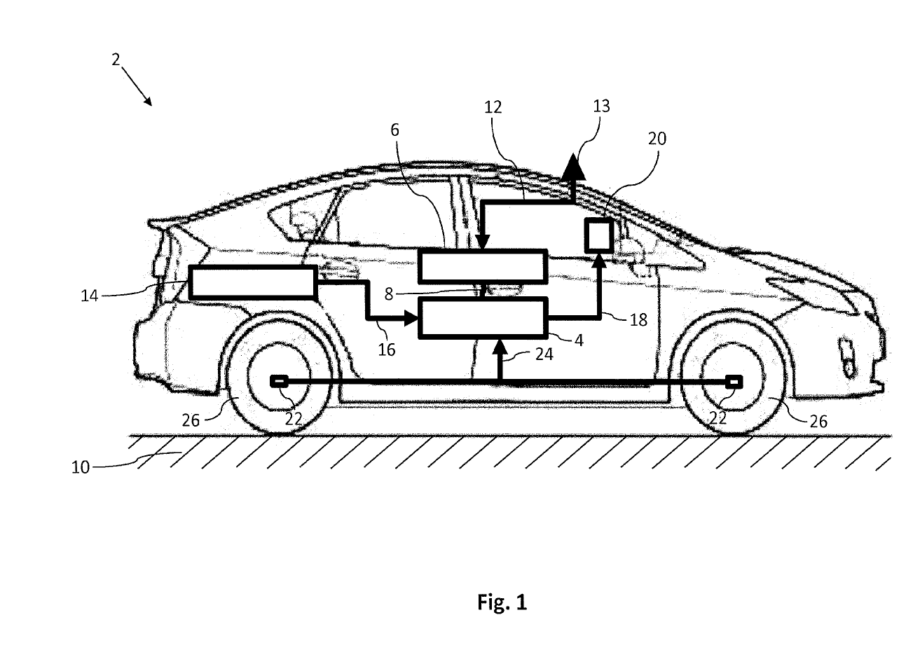

Reference is made to FIG. 1, which shows a basic illustration of a vehicle 2 with a fusion sensor 4.

In the present embodiment, the fusion sensor 4 uses an inherently known GNSS receiver 6 to receive location data 8 for the vehicle 2, which comprise an absolute position of the vehicle 2 on a roadway 10. Besides the absolute position, the location data 8 from the GNSS receiver 6 also comprise a speed of the vehicle 2. In the present embodiment, in a manner that is known to a person skilled in the art, the location data 8 from the GNSS receiver 6 are derived from a GNSS signal 12 in the GNSS receiver 6, which GNSS signal is received via a GNSS antenna 13, and therefore subsequently called GNSS location data 8. For details in this regard, reference is made to the relevant specialist literature.

In a manner that is yet to be described, the fusion sensor 4 is designed to enhance the information content of the GNSS location data 8 derived from the GNSS signal 12. This is firstly necessary because the GNSS signal 12 has a very low signal-to-noise ratio and can thus be very inaccurate. Secondly, the GNSS signal 12 is not continuously available.

In the present embodiment, the vehicle 2 has, to this end, a motion determination device 14 that captures driving dynamics data 16 for the vehicle 2. These are known to include longitudinal acceleration, transverse acceleration and also vertical acceleration and a roll rate, a pitch rate and a yaw rate for the vehicle 2. In the present embodiment, these driving dynamics data 16 are used in order to enhance the information content of the GNSS location data 8 and, by way of example, to more precisely specify the position and the speed of the vehicle 2 on the roadway 10. The more precisely specified location data 18 can then be used by a navigation appliance 20 even if the GNSS signal 12 is unavailable at all, for example in a tunnel.

To further enhance the information content of the GNSS location data 8, the present embodiment can optionally also make use of wheel speed sensors 22 that capture the wheel speeds 24 of the individual wheels 26 of the vehicle 2.

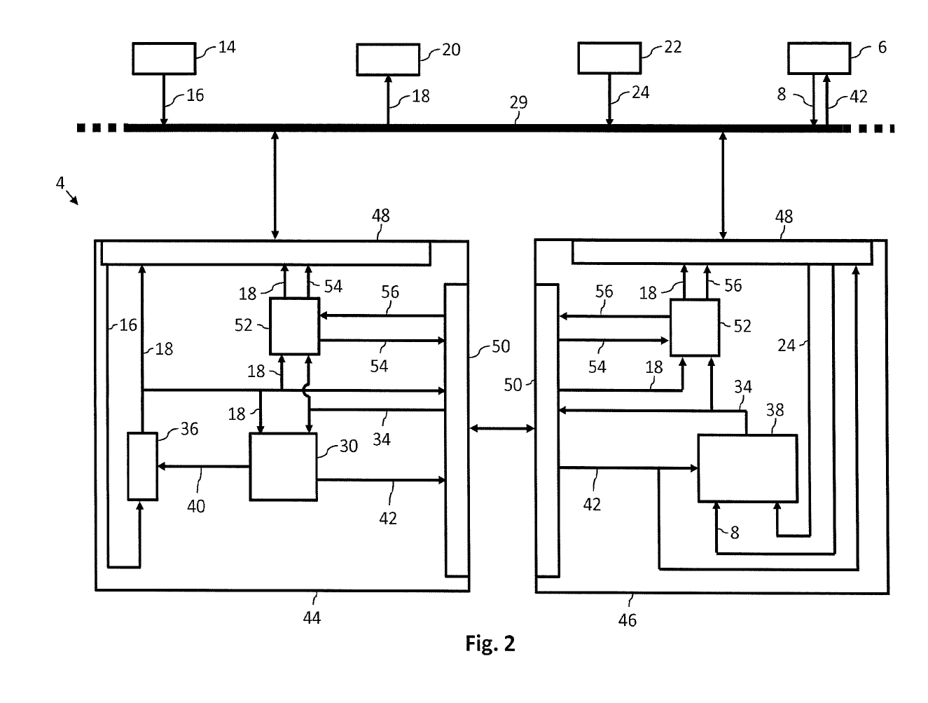

Reference is made to FIG. 2, which shows a basic illustration of the fusion sensor 4 from FIG. 1.

In the present embodiment, the fusion sensor 4 has a special structure that will be discussed in more detail later.

The fusion sensor 4 receives the measurement data already mentioned in FIG. 1, which are interchanged between the sensors 6, 14, 22, the fusion sensor 4 and the navigation appliance 20 via a data bus 29. By way of example, the data bus 29 may be designed as a controller area network bus, called a CAN bus. A detailed explanation of the elements within the fusion sensor 4 that are involved in the data transmission, such as interfaces and so on, will be discussed in more detail later.

The fusion sensor 4 is intended to output the more precisely specified location data 18. The fundamental idea behind this is to contrast the information from the GNSS location data 8 and the driving dynamics data 16 from the motion determination device 14 in a filter 30 and thus to increase a signal-to-noise ratio in the location data 8 from the GNSS receiver 6 or the driving dynamics data 16 from the motion determination device 14. To this end, although the filter may be in any form, a Kalman filter achieves this object most effectively with a comparatively low computation resource requirement. Therefore, the filter 30 will preferably be a Kalman filter 30 below.

The Kalman filter 30 receives the more precisely specified location data 18 for the vehicle 2 and comparison location data 34 for the vehicle 2. In the present embodiment, the more precisely specified location data 18 are generated in a strapdown algorithm 36 which is known from DE 10 2006 029 148 A1, being incorporated by reference herein for example, from the driving dynamics data 16. They contain more precisely specified position information about the vehicle 2, but also other location data about the vehicle 2, such as its speed, its acceleration and its heading. By contrast, the comparison data 34 are obtained from a model 38 of the vehicle 2 that is firstly supplied with the GNSS location data 8 from the GNSS receiver 6. From these GNSS location data 8, the comparison location data 34 are then determined in the model 38, said comparison location data containing the same information as the more precisely specified location data 18. The more precisely specified location data 18 and the comparison location data 34 differ merely in their values.

The Kalman filter 30 takes the more precisely specified location data 18 and the comparison location data 34 as a basis for computing an error budget 40 for the more precisely specified location data 18 and an error budget 42 for the comparison location data 34. An error budget is intended to be understood below to mean a total error in a signal, said total error being made up of various single errors in the capture and transmission of the signal. In the case of the GNSS signal 12 and hence in the case of the GNSS location data 8, a corresponding error budget can be made up of errors in the satellite orbit, in the satellite clock, in the remnant refraction effects and of errors in the GNSS receiver 6, which can be corrected by the latter by returning the error budget 42 to the GNSS receiver 6, for example.

The error budget 40 of the more precisely specified location data 18 and the error budget 42 of the comparison location data 34 are then accordingly supplied to the strapdown algorithm 36 and the model 38 for the purpose of correcting the more precisely specified location data 18 and the comparison location data 34. That is to say that the more precisely specified location data 18 and the comparison location data 34 are iteratively purged of their errors.

In the present embodiment, the strapdown algorithm 36 and the Kalman filter 30 are intended to be executed on a first processor 44 in the form of an algorithm, which is a separate computation unit from a second processor 46 on which the model 38 is computed. If the second processor 46 fails, for example, the more precisely specified location data 18 continue to be output even though this type of more specified location data 18 is subject to greater location tolerance on account of the missing comparison location data 34.

In a manner that is not illustrated further for reasons of clarity, the second processor 46 could also, in the event of failure of the first processor 44, output the comparison location data 34 as more precisely specified location data 18 in order to continue, in such an error situation, at least the basic functionality of the fusion sensor 4 with the aforementioned greater location tolerance in the more precisely specified location data 18.

For the purpose of interchanging the aforementioned measurement data 8, 16, 18, 22 between the sensors 6, 14, 22, the fusion sensor 4 and the navigation appliance 20 via the bus 29, the two processors 44, 46 each have a bus interface 48 that can be used to interchange these measurement data 8, 16, 18, 22. For the purpose of interchanging the more precisely specified location data 18, the comparison location data 34 and the error budget 42 among one another, the two processors 44, 46 in the present embodiment each have a direct interface 50. Alternatively, these data could likewise be transmitted via the bus 29 with correspondingly higher transmission latency, however.

In the present embodiment, the two processors 44, 46 are intended to monitor one another for their error-free operating state. To this end, a plausibilization algorithm 52 is executed in each processor 44, 46 in the present embodiment.

By way of example, each plausibilization algorithm 52 could plausibilize the more precisely specified location data 18 on the basis of the comparison location data 34 by means of contrasting, in which case in the error situation it would not be clear whether the more precisely specified location data 18 or the comparison location data 34 are erroneous and hence accordingly the first processor 44 or the second processor 46 is subject to erroneous operation.

Therefore, the present embodiment involves the proposal that each plausibilization algorithm 52 computes residuals on the basis of a comparison model, which is not illustrated further, by inserting the more precisely specified location data 18 and/or the comparison location data 34 into the comparison model. By way of example, the first processor 44 could compute comparison residuals 54 on the basis of the comparison location data 34, while the second processor 46 computes main residuals 56 on the basis of more precisely specified location data 18. Both processors 44, 46 could interchange these residuals 54, 56 with one another for the purpose of comparison.

One processor 44, 46 on its own or both processors 44, 46 can alternatively or additionally also continuously feed the residuals 54, 56, which are accordingly computed on the basis of the location data 18, 34 from the other processor 46, 44, together with their own location data 18, 34 into the bus 29 so that the receivers of the more precisely specified location data 18, such as the navigation appliance 20, can independently take the residuals 54, 56 as a basis for deciding which of the location data 18, 34 they use for their own operation.

In a particularly advantageous manner, the plausibilization algorithm 52 can be executed in at least one of the two processors 44, 46 as part of an inherently known cryptoprocess, for example in order to prevent the concealment of performance-enhancing manipulations on the vehicle 2 by means of manipulations on the plausibilization algorithm 52.

1. An apparatus for outputting a measurement signal that indicates a physical measured variable in a vehicle, comprising:
a first processor that is set up to take a first sensor signal as a basis for determining a first comparison signal for the physical measured variable,
a second processor that is set up to take a second sensor signal as a basis for determining a second comparison signal for the physical measured variable, and
a filter device that is set up to determine an error between the two comparison signals and to output said error to the first processor,
wherein the first processor is set up to determine the measurement signal on the basis of a correction of the first comparison signal with the error.

2. The apparatus as claimed in claim 1, wherein one of the sensor signals is a global satellite navigation signal, the other of the sensor signals is a driving dynamics signal and the physical measured variable is a locating signal that locates the vehicle in terms of its absolute position and its change of position.

3. The apparatus as claimed in claim 1, wherein at least one processor is set up to monitor the accordingly other processor.

4. The apparatus as claimed in claim 3, wherein the monitoring processor is set up to compute a residual between the comparison signal from the monitored processor and a model for the physical measured variable.

5. The apparatus as claimed in claim 4, wherein the monitoring processor is set up to monitor the operation of the monitored processor on the basis of contrasting of the computed residual and a setpoint value.

6. The apparatus as claimed in claim 5, wherein the monitoring processor is set up to output its determined comparison signal as a measurement signal when the operation of the monitored processor is identified as erroneous.

7. The apparatus as claimed in claim 6, wherein in the event of error in the monitored processor the monitoring processor is set up to provide the measurement signal with a piece of information about the failure of the monitored processor.

8. The apparatus as claimed in claim 4, wherein the monitoring processor is set up to logically combine, and output, its comparison signal with the computed residual.

9. The apparatus as claimed in claim 3, wherein the monitoring processor is a cryptoprocessor.

10. A vehicle comprising an apparatus as claimed in claim 1.

11. The apparatus as claimed in claim 2, wherein at least one processor is set up to monitor the accordingly other processor.
